(19) United States
(12) Patent Application Publication
(10) Pub. No.: US 2020/0190229 A1
(43) Pub. Date: Jun. 18, 2020

(54) ZIEGLER-NATTA CATALYST AND PREPARATION THEREOF

(71) Applicant: BOREALIS AG, Vienna (AT)

(72) Inventors: Peter DENIFL, Linz (AT); Timo LEINONEN, Tolkkinen (FI); Ville NISSINEN, Joensuu (FI); Tuula PAKKANEN, Joensuu (FI); Andrey BAZHENOV, Jyväskylä (FI); Mikko LINNOLAHTI, Joensuu (FI); Tapani PAKKANEN, Joensuu (FI)

(21) Appl. No.: 16/472,426

(22) PCT Filed: Dec. 7, 2017
(86) PCT No.: PCT/EP2017/081764

§ 371 Date: Jun. 21, 2019

(30) Foreign Application Priority Data
Dec. 22, 2016 (EP) 16206419.0

(51) Int. Cl. C08F 4/659; C08F 10/02; C08F 4/02; C08F 10/14; C08F 10/08; C08F 10/06

(52) U.S. Cl. CPC C08F 4/65916; C08F 10/02; C08F 10/06; C08F 10/14; C08F 10/08; C08F 4/022

(57) ABSTRACT

The present invention relates to a solid Ziegler-Natta catalyst component comprising transition metal compound of Group 4 to 6, and a polymeric nitrogen containing electron donor, preferably selected from linear or branched polyalkyleneimines or isomers or mixtures therefrom. The invention relates further to the use of said polymeric internal electron donor in a solid Ziegler-Natta catalyst component, a catalyst comprising said solid Ziegler-Natta catalyst component and a cocatalyst, and use of said catalyst in producing C₂ to C₆ olefin (co)polymers.

This invention relates to a solid Ziegler-Natta catalyst component for producing olefin polymers and preparation of said catalyst component. Further, the invention relates to a Ziegler Natta catalyst comprising said solid catalyst component, a Group 13 metal compound as a cocatalyst and optionally external electron donors. The invention further relates to the use of said catalyst component in producing olefin polymers, especially ethylene and propylene polymers.

### BACKGROUND OF THE INVENTION

Ziegler-Natta (ZN) type polyolefin catalysts are well known in the field of producing olefin polymers, like ethylene and propylene (co)polymers. Generally the catalysts comprise at least a catalyst component formed from a transition metal compound of Group 4 to 6 of the Periodic Table (IUPAC, Nomenclature of Inorganic Chemistry, 1989), a metal compound of Group 1 to 3 of the Periodic Table (IUPAC), and optionally a compound of Group 13 metal of the Periodic Table (IUPAC) and optionally an internal electron donor. A ZN catalyst may also comprise further catalyst component(s), such as a cocatalyst and optionally an external electron donor.

A great variety of Ziegler-Natta catalysts have been developed to fulfill the different demands in reaction characteristics and for producing poly(alpha-olefin) resins of desired physical and mechanical performance. Typical Ziegler-Natta catalysts contain a magnesium compound, a titanium compound and optionally an aluminium compound supported on a particulate support. The commonly used particulate supports are Mg dihalide, preferably MgCl₂, based supports, or inorganic oxide type of supports, such as silica, alumina, titania, silica-alumina and silica-titania, typically silica.

Typical Ziegler-Natta catalysts based on MgCl₂ contain a titanium compound and optionally a Group 13 compound, for example, an aluminium compound. Such catalysts are disclosed, for instance, in EP376936, WO 2005/118655 and EP 810235.

The catalyst can be prepared by sequentially contacting the inorganic support with the above mentioned compounds, for example, as described in EP 688794 and WO 99/51646. Alternatively, it can be prepared by first preparing a solution from the components and then contacting the solution with a support, as described in WO 01/55230.

The above described ZN-catalysts are claimed to be useful in olefin polymerisation, for example the production of ethylene (co)polymers.

However, even though many catalysts of prior art show satisfactory properties for many applications there has been the need to modify and improve the properties of the catalysts to achieve desired performance in desired polymerisation processes and to obtain desired polymer properties.

Further, nowadays HSE- (health, safety & environment) policies are important factors in the production of catalysts and further of polymers. In other words, the polymers must fulfill the strict health and environmental requirements of national and international institutions. One class of substances, which are considered to be potentially harmful compounds, is e.g. phthalates, which have been commonly used as internal electron donors in Ziegler-Natta type catalysts.

There have been several attempts to find solutions for producing catalysts without using any non-hazardous or in environmentally and health point of view non-desired compounds in catalyst preparation. One way to modify the catalyst is to use internal electron donors or other compounds affecting the performance of the catalyst, Further, external electron donors and/or alkyl halides may be used. Therefore finding internal electron donors being acceptable in HSE point of view is an essential problem to be solved in catalyst development.

U.S. Pat. No. 5,055,535 discloses a method for controlling the molecular weight distribution (MWD) of polyethylene homopolymers and copolymers using a ZN catalyst comprising an electron donor selected from monoethers (e.g. tetrahydrofuran). Use of monoethers, like tetrahydrofuran, is also disclosed e.g. in WO 2007051607 and WO2004055065.

EP0376936 discloses a MgCl₂ supported ZN catalyst, where spray-dried MgCl₂/alcohol support material is treated with a compound of group IA to IIIA (Groups 1, 2 and 13 of the Periodic Table (IUPAC, Nomenclature of Inorganic Chemistry, 1989)) then titanated with a titanium compound, optionally in the presence of internal electron donor. The optional internal donor compound is exemplified to be THF or di-isobutyl phthalate.

EP591224 discloses MgCl₂-based Ziegler-Natta catalyst, where the solid support material is prepared by spray-crystallisation method. As internal donor in catalyst preparation is used phthalic compounds, typically di-2-ethylhexyl phthalates.

In the patent literature there are also widely described Ziegler-Natta catalysts, especially catalysts for propylene polymerisation, comprising non-phthalic esters, like succinates, maleates and benzoates as well diethers or combinations thereof with e.g. phthalates.

All the donors described above are monomeric compounds.

Although much development work in Ziegler-Natta catalyst preparation has been done, there is still room for improvement. In addition to the needs of catalyst properties and performance, like productivity, the chemicals used in the preparation should be from a health, safety and environment point of view acceptable compounds.

### SUMMARY OF THE INVENTION

It has now been surprisingly found that many problems of the prior art can be solved, when a specific group of internal electron donors is used in preparing solid Ziegler-Natta catalyst.

Thus, the object of the present invention is to provide a solid Ziegler-Natta catalyst component comprising as an internal electron donor a polymeric compound, especially a nitrogen containing polymeric compound. Further, the object of the present invention is to provide a new method for preparing a solid Ziegler-Natta based catalyst component, where a nitrogen containing polymeric nitrogen containing internal electron donor is added to the catalyst synthesis. Further, the invention relates to a catalyst comprising said solid Ziegler-Natta catalyst component, a cocatalyst and optionally external electron donor(s). In addition, the object of the present invention is to use a polymeric compound, as described below, as internal electron donor in Ziegler-Natta catalyst components. Finally, an additional object of the present invention is the use of the solid Ziegler-Natta catalyst component prepared by the method of the invention in olefin polymerisation process.

In the present disclosure, the term internal electron donor denotes a compound being part of the solid catalyst component, i.e. added during the synthesis of the solid catalyst component. External additives, like external electron donors, mean a component being not part of the solid catalyst component, but fed as separate component to the polymerisation process.

### DETAILED DESCRIPTION OF THE INVENTION

Accordingly, the present invention relates to solid Ziegler-Natta catalyst component comprising a transition metal compound of Group 4 to 6, and a polymeric internal electron donor, selected from nitrogen containing polymeric compounds. The polymeric internal electron donor is preferably selected from linear or branched polyalkylene imines, as defined in formula I, or isomers or mixtures therefrom.

H₂N—(CH₂)ₐ—[(CH₂)_{b}—(N(R¹)-L-)ₙ-(CH₂)_{c}]ₘ—(CH₂)_{d}—NH₂ (I)

wherein,

each a, b, c and d is an integer of 1 to 4, preferably 1 to 2,

n is an integer 3 to 7, preferably 4 to 6,

m is an integer 2 to 100, preferably 2 to 60,

each L is independently an alkylene of 1 to 4 C-atoms, preferably an alkylene of 2 C-atoms

each R¹ is independently H, or a group -L-(N(R²)_{z}(R³)_{y}, wherein L is as defined above, each R² and R³ are independently H or an C₁ to C₄ amino alkyl, and z and y are 0, 1 or 2, provided that the sum z+y is 2.

According to a preferred embodiment each a, b, c and d are 2 and L is ethylene.

According to a further preferred embodiment at least one of R¹ in formula (I) is a group -L-(N(R²)_{z}(R³)_{y}. Further, it is especially preferred that at least one of R² and R³ is C₁ to C₄ amino alkyl, preferably an amino ethyl group.

An example for a typical structure representing a branched polyalkyleneimines of formula (II)

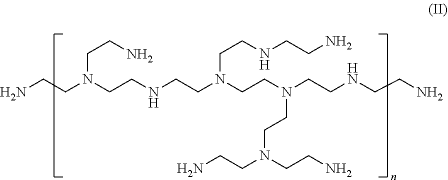

Further, the present invention relates to a method for producing solid Ziegler-Natta catalyst component comprising the steps
a) providing solid catalyst support particles
b) treating the solid catalyst support particles of step a) with a nitrogen containing polymeric internal electron donor, as defined in formula I and a transition metal compound of Group 4 to 6
c) recovering the solid catalyst component

Further, the present invention relates to the use of nitrogen containing polymeric internal electron donor as defined in formula I in solid Ziegler-Natta catalysts.

Further, one object of the invention is to produce C₂ to C₁₀ olefin (co)polymers in the presence of the catalyst in accordance with the present invention. The catalyst of the present invention or produced by the inventive method is especially suitable for producing C₂ to C₆ olefin (co)polymers.

### PREFERRED EMBODIMENTS

The invention will be described in the following in more detail, referring to the particular preferred embodiments. Preferred embodiments are disclosed in dependent claims as well in the following description.

As used herein, the term Ziegler Natta (ZN) catalyst component is intended to cover a catalyst component comprising a transition metal compound of Group 4 to 6, Nomenclature of Inorganic Chemistry, 1989) and an internal electron donor of formula (I).

The transition metal compound of Group 4 to 6 is preferably a Group 4 transition metal compound or a vanadium compound and is more preferably a titanium compound. Particularly preferably the titanium compound is a halogen-containing titanium compound of the formula X_{y}Ti(OR⁸)_{4-y}, wherein R⁸ is a C₁₋₂₀ alkyl, preferably a C₂₋₁₀ and more preferably a C₂₋₈ alkyl group, X is halogen, preferably chlorine and y is 1, 2, 3 or 4, preferably 3 or 4 and more preferably 4.

Suitable titanium compounds include trialkoxy titanium monochlorides, dialkoxy titanium dichloride, alkoxy titanium trichloride and titanium tetrachloride. Preferably a titanium tetrachloride is used.

According to further preferred embodiment the internal electron donor is of formula (I), where each of a, b, c and d are 2, and L is ethylene.

According to a further preferred embodiment at least one of R¹ in formula (I) is a group -L-(N(R²)_{z}(R³)_{y}. Further, it is especially preferred that at least one of R² and R³ is amino C₁ to C₄ alkyl, preferably an amino ethyl group.

An example for a typical structure representing a branched polyethyleneimine compound is of formula (II)

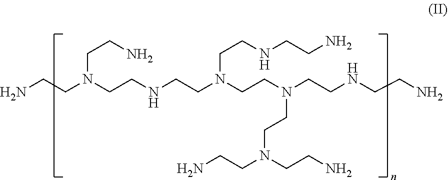

According to a further preferred embodiment the catalyst comprises a Group 2 compound, preferably a Mg compound. A Mg compound is typically used in preparing catalyst support material.

As indicated in prior art description components of catalyst may be supported on a particulate support, such as Mg dihalide, preferably MgCl₂, based support, or inorganic oxide, like silica or alumina based supports. Many typical catalysts, based on inorganic oxides, like silica support, contain Mg, which is added to the catalyst synthesis as a Mg compound. The magnesium compound may be a reaction product of a magnesium dialkyl and an alcohol, typically an alcohol bearing 6 to 16 carbon atoms.

Typically, MgCl₂ based supports are prepared by mixing MgCl₂ with an alcohol (ROH), whereby the alcohol is coordinated with MgCl₂. The solid support MgCl₂*mROH is formed according to the well know methods. As examples, spray drying or spray crystallisation methods may be used to prepare the MgCl₂ based supports. Spherical and granular MgCl₂*mROH support materials are suitable to be used in the present invention. The alcohol in producing MgCl₂*mROH support material is an alcohol ROH, where R is a linear or branched alkyl group containing 1 to 12 carbon atoms, preferably 1 to 8 carbon atoms, like 1 to 4 carbon atoms. Ethanol is typically used as an alcohol. In MgCl₂*mROH, m is 0.2 to 6.0, more preferably 1.0 to 4.0, especially 2.0 to 3.8.

Preparation methods of MgCl₂*mROH support is described in several patents e.g. in EP376936, EP424049, EP65507, U.S. Pat. No. 4,071,874 and EP614467, which are incorporated here by reference.

It is also possible to form the MgCl₂ based catalyst starting from metallic magnesium, which is reacted with chlorinated alkane compound in an organic solvent.

The Ziegler-Natta catalyst component may also contain a Group 13 metal compound, preferably an aluminium compound. Particularly preferably the aluminium compound is an aluminium compound of the formula Al(alkyl)ₓX₃₋ₓ (II), wherein each alkyl is independently an alkyl group of 1 to 12 carbon atoms, preferably 1 to 8 carbon atoms, more preferably 1 to 6 carbon atoms, X is halogen, preferably chlorine and 1<x≤3. The alkyl group can be linear, branched or cyclic, or a mixture of such groups.

Preferred aluminium compounds are dialkyl aluminium chlorides or trialkyl aluminium compounds, for example dimethyl aluminium chloride, diethyl aluminium chloride, di-isobutyl aluminium chloride, and triethylaluminium or mixtures therefrom. Most preferably the aluminium compound is a trialkyl aluminium compound, especially triethylaluminium compound.

According to the method of the present invention it is an essential feature that the internal electron donor, as defined above, is added to the catalyst synthesis.

Preferably the support in the present invention is a MgCl₂ based support. Said support is preferably prepared by contacting MgCl₂ with ethanol and using spray drying or spray crystallisation to form the final solid support material.

Thus, according to the first preferred embodiment of the invention the solid catalyst component is prepared by
i) providing solid MgCl₂ based support,
ii) contacting the solid support of step i) with the polymeric internal electron donor of compound of formula (I),
iii) treating the solid support obtained in step ii) with TiCl₄ or
iii′) simultaneously with step ii) contacting the solid support with TiCl₄, and
iv) recovering the solid catalyst component.

The final solid catalyst component shall have the internal electron donor of formula (I) in an amount of 2 to 30 wt-%, preferably 2 to 25 wt-%, or even in the range of 2 to 15 wt-%. Ti amount is in the range of 1.5 to 10 wt-%, typically 1.8 to 8 wt-%.

The solid MgCl₂ based support is preferably prepared by mixing MgCl₂ with an alcohol (ROH) and the solid support MgCl₂*mROH is formed by known methods. As example, spray drying or spray crystallisation methods can be used to prepare MgCl₂ based support. The alcohol in producing MgCl₂*mROH support material is an alcohol ROH, where R is a linear or branched alkyl group containing 1 to 12 carbon atoms, preferably 1 to 8 carbon atoms, like 1 to 4 carbon atoms, typically ethanol. In MgCl₂*mROH, m is 0.2 to 6.0, more preferably 1.0 to 4.0, especially 2.0 to 3.8, like 2.5 to 3.5.

The activity (g polymer/(g cat*h) of the catalysts of the invention remains at an acceptable level or is even increased compared to use of a catalyst component of similar type but using a non-polymeric compound as an internal electron donor.

The catalyst of the invention comprises, in addition to the solid catalyst component as defined above, a cocatalyst, which is also known as an activator. Cocatalysts are organometallic compounds of Group 13 metal, typically aluminum compounds. These compounds include alkyl aluminium halides, preferably alkyl aluminium chlorides, such as ethylaluminium dichloride, diethylaluminium chloride, ethylaluminium sesquichloride, dimethylaluminium chloride and the like. They also include trialkylaluminium compounds, such as trimethylaluminium, triethylaluminium, tri-isobutylaluminium, trihexylaluminium and tri-n-octylaluminium. Also other aluminium alkyl compounds, such as isoprenylaluminium, may be used. Especially preferred cocatalysts are trialkylaluminiums, of which triethylaluminium, trimethylaluminium and tri-isobutylaluminium are particularly used.

The catalyst of the invention may also comprise an external additive, like an external electron donor. Suitable external electron donors include ether compounds, siloxanes or silanes and/or alkyl halides as is known from prior art. Siloxanes or silanes are commonly used as external electron donors especially in producing propylene polymers.

The catalyst of the present invention can be used for polymerising C₂ to C₁₀ olefin, preferably C₂ to C₆ olefin, optionally with one or more comonomers. Most commonly produced olefin polymers are polyethylene and polypropylene or copolymers thereof. Commonly used comonomers are alpha-olefin comonomers preferably selected from C₂-C₂₀-alpha-olefins, more preferably are selected from C₂-C₁₀-alpha-olefins, such as ethylene, 1-butene, isobutene, 1-pentene, 1-hexene, 4-methyl-1-pentene, 1-heptene, 1-octene, 1-nonene and 1-decene, as well as dienes, such as butadiene, 1,7-octadiene and 1,4-hexadiene, or cyclic olefins, such as norbornene, and any mixtures thereof. Most preferably, the comonomer is ethylene, 1-butene and/or 1-hexene.

Catalyst of the present invention can be used in any commonly used uni- and multimodal processes for producing polyolefins. The polymerizations may be operated in slurry, solution, or gas phase conditions or their combinations. Typically ethylene and propylene (co)polymers are produced in commercial scale in a multimodal process configuration. Such multimodal polymerization processes known in the art comprise at least two polymerization stages. It is preferred to operate the polymerization stages in cascaded mode. Suitable processes comprising cascaded slurry and gas phase polymerization stages are disclosed, among others, in WO92/12182 and WO96/18662 and WO WO98/58975.

In a multimodal polymerisation configuration, the polymerisation stages comprise polymerisation reactors selected from slurry and gas phase reactors. In one preferred embodiment, the multimodal polymerisation configuration comprises at least one slurry reactor, followed by at least one gas phase reactor.

The catalyst may be transferred into the polymerization process by any means known in the art. It is thus possible to suspend the catalyst in a diluent and maintain it as homogeneous slurry. Especially preferred is to use oil having a viscosity from 20 to 1500 mPa·s as diluent, as disclosed in WO-A-2006/063771. It is also possible to mix the catalyst with a viscous mixture of grease and oil and feed the resultant paste into the polymerization zone. Further still, it is possible to let the catalyst settle and introduce portions of thus obtained catalyst mud into the polymerization zone in a manner disclosed, for instance, in EP-A-428054.

The polymerization in slurry may take place in an inert diluent, typically a hydrocarbon diluent such as methane, ethane, propane, n-butane, isobutane, pentanes, hexanes, heptanes, octanes etc., or their mixtures. Preferably the diluent is a low-boiling hydrocarbon having from 1 to 4 carbon atoms, like propane or a mixture of such hydrocarbons. In propylene polymerisation the monomer is usually used as the reaction medium.

The temperature in the slurry polymerization is typically from 40 to 115° C., preferably from 60 to 110° C. and in particular from 70 to 100° C. The pressure is from 1 to 150 bar, preferably from 10 to 100 bar.

The slurry polymerization may be conducted in any known reactor used for slurry polymerization. Such reactors include a continuous stirred tank reactor and a loop reactor. It is especially preferred to conduct the polymerization in loop reactor. Hydrogen is fed optionally into the reactor to control the molecular weight of the polymer as known in the art. Furthermore, one or more alpha-olefin comonomers may be added into the reactor. The actual amount of hydrogen and comonomer feeds depends on the desired melt index (or molecular weight), density or comonomer content of the resulting polymer.

The polymerization in gas phase may be conducted in a fluidized bed reactor, in a fast fluidized bed reactor or in a settled bed reactor or in any combination of these.

Typically, the fluidized bed or settled bed polymerization reactor is operated at a temperature within the range of from 50 to 100° C., preferably from 65 to 90° C. The pressure is suitably from 10 to 40 bar, preferably from 15 to 30 bar.

Also antistatic agent(s) may be introduced into the slurry and/or gas phase reactor if needed. The process may further comprise pre- and post-reactors.

The polymerization steps may be preceded by a pre-polymerisation step. The pre-polymerisation step may be conducted in slurry or in gas phase. Preferably, pre-polymerisation is conducted in slurry, and especially in a loop reactor. The temperature in the pre-polymerisation step is typically from 0 to 90° C., preferably from 20 to 80° C. and more preferably from 30 to 70° C.

The pressure is not critical and is typically from 1 to 150 bar, preferably from 10 to 100 bar.

The polymerisation may be carried out continuously or batch wise, preferably the polymerisation is carried out continuously.

### EXPERIMENTAL PART

Measurement Methods

Mg, Ti and Organic Compound Amounts in the Catalysts

Magnesium contents of the products were determined by a complexometric EDTA (ethylenediaminetetra-acetic acid) titration. ¹H-NMR spectroscopy (Bruker Avance 400 spectrometer) was used to determine the amounts of organic compounds in the complexes. For the analysis, solid products were dissolved in 10% (V/V) D₂SO₄/D₂O solution. Number of scans was 32 and relaxation delay 10 s. Sodium acetate was used as an internal standard. Titanium contents of the catalysts were determined by a spectrophotometric method, in which the solids were dissolved in H₂SO₄ solution and addition of H₂O₂ gave solutions of a yellow complex. Reference is made to Vogel, A. I. In A Text-Book of Quantitative Inorganic Analysis Including Elementary Instrumental Analysis, 3rd ed.; Longman: London, 1961; pp 788-790. Shimadzu UVmini-1240 spectrophotometer was used to measure absorbances of the solutions at 410 nm wavelength.

Melt Flow Rate

MFR₂: 190° C., 2.16 kg load; MFR₅: 190° C., 5 kg load and MFR₂₁: 190° C., 21 kg load

The melt flow rate is measured in accordance with ISO 1133 and is indicated in g/10 min. The MFR is an indication of the flowability, and hence the processability, of the polymer. The higher the melt flow rate, the lower the viscosity of the polymer.

FFR21/2 is the ratio of MFR₂₁/MFR₂.

Melting Temperature (Mp)

Melting temperature is measured by Differential Scanning calorimeter (DSC) according to ISO 11357 using Mettler TA820 Differential Scanning calorimeter (DSC) on 3±0.5 mg samples.

Comonomer (1-Butene) Amount in Polyethylene

The amount of 1-butene in polyethylene copolymer was measured using FTIR spectroscopy according to ASTM D6645-01. The metal plate used in polymer plaque pressing was covered with silicon paper. The calibration was carried out by plotting measured A(1378 cm⁻¹)/Area(2019 cm⁻¹) of the polymer standards to known comonomer wt-%. The instrument used is Bruker Tensor 37.

### EXAMPLES

Raw Materials

TiCl₄ (CAS 7550-45-90) was supplied by commercial source.

PEI (branched polyethylenimine, M_{w}˜800 g/mol)

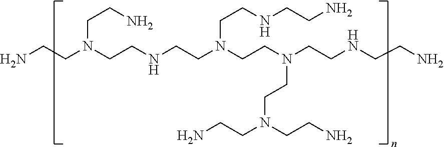

n=˜2

CAS 25987-06-8, provided by Aldrich (408719)MgCl₂/PEI support:

δ-MgCl₂ was synthesized using a method reported in Di Noto, V.; Bresadola, S. New Synthesis of a Highly Active 5-MgCl₂ for MgCl₂/TiCl₄/AlEt₃ Catalytic Systems. Macromol. Chem. Phys. 1996, 197, 3827-3835.

### Example 1

Preparation of MgCl₂-EtOH Support

A nitrogenated autoclave of capacity 110 l was charged with 35 kg of dry MgCl₂ and 80 l of dry ethanol. The reaction mixture was melted at 140° C. with mixing. After mixing of 8 hours, the clear, homogenized mixture was supplied using compressed nitrogen at a rate of 10 kg/h with the aid of a nozzle into spray chamber cooled with nitrogen to −20° C.

### Example 2

Preparation of the Catalysts CAT1 and CAT2

Branched polyethyleneimine (PEI) was first added to MgCl₂-EtOH support prepared according to Example 1 in an autoclave. MgCl₂-EtOH support, PEI and toluene were packed to the autoclave in a clove box. A PEI/Mg molar ratio of 0.9 was used. The autoclave was heated at 90° C. for 22 h. The product formed was separated with a filtration and washed with toluene.

Addition of TiCl₄ to MgCl₂/EtOH/PEI support was conducted in a glass reactor. A slurry of support (2.6 g) and heptane (12 ml) was prepared in a clove box. The slurry was constantly mixed with a magnetic stirrer and cooled to 10° C. TiCl₄ (16 ml; (Ti)/(EtOH) mol/mol=5.5) was added slowly. During the addition of TiCl₄ color of the support turned to yellow. After 30 min of mixing, temperature of the system was slowly raised until temperature of 110° C. was reached. After 60 minutes of mixing, liquid phase of the reaction mixture was removed using a double ended needle. The product was washed twice with TiCl₄/toluene mixture (1:1 vol/vol) (110° C.), once with toluene (90° C.) and 3 times with heptane (90° C.). The product was dried in vacuum at room temperature for one day. The catalyst obtained is denoted by CAT 1.

CAT1 was further washed in order to remove remaining impurities (mainly titanium ethoxide). The catalyst was washed twice with TiCl₄ (110° C.), four times with toluene (110° C.) and twice with heptane (room temperature). The catalyst was dried in vacuum at room temperature for one day. The catalyst obtained is denoted by CAT2.

PEI/Mg mass and molar ratios in different steps of the catalyst preparation are presented in Table 1. PEI/Mg mass and molar ratios stayed constant during the whole catalyst preparation, indicating strong coordination of PEI to MgCl₂, as shown in Table 1. The addition of TiCl₄ or even extensive washing did not decrease the PEI content of the catalyst.

TABLE 1
PEI/Mg ratios in different steps of catalyst
preparation and in final catalyst

| | PEI/Mg | (PEI)/(Mg) |
|---|---|---|
| Preparation step/product | wt/wt | Mol/mol |
| Addition of PEI to MgCl₂/EtOH support* | 1.6 | 0.92 |
| MgCl₂/EtOH/PEI in support | 1.7 | 0.96 |
| CAT2 | 1.7 | 0.96 |

*amounts of reagents put into the reaction mixture

Ethylene Homopolymerization

For ethylene polymerization, 15-25 mg of catalyst, 50 ml heptane and triethyl aluminum (molar ratio Al/Ti=100) were packed to an autoclave. The autoclave was heated to 50° C. The ethylene feed (2 bar) was started after 30 min from the beginning of the heating. After 60 min from the starting of the ethylene feed, polymerization was stopped by venting off the ethylene gas and by adding acidic ethanol. Polyethylene formed was washed with ethanol and dried at 60° C. PEI, Ti and EtO contents in the catalysts CAT1 and CAT2, and activity of CAT1 and CAT2 are disclosed in Table 2.

TABLE 2
PEI, Ti and EtO contents and activity of CAT1 and CAT2

| | PEI | Ti | EtO | Activity |
|---|---|---|---|---|
| | wt-% | wt-% | wt-% | gPE/(gcat*h) |
| CAT1 | 10.8 | 7.7 | 5.7 | 360 |
| CAT2 | 24.4 | 4.2 | 1.5 | 350 |

### Example 3

Preparation of the Catalyst CAT3

MgCl₂/PEI support was prepared by adding branched PEI on δ-MgCl₂. Synthesis of δ-MgCl₂ was conducted with Grignard-Wurtz reaction in an autoclave without any electron donor using metallic Mg and 1-chlorobutane as starting materials and octane as solvent. After washing and drying, δ-MgCl₂ was recrystallized in the presence of PEI in an autoclave. Toluene was used as solvent. The autoclave was heated at 130° C. for 2 h. After washing and drying the product, TiCl₄ was introduced to the system. Addition of TiCl₄ was conducted in an autoclave using toluene as solvent (100° C./2 h). A Ti/Mg molar ratio of 10:1 was used. After heating, the product was washed (twice with 10 ml toluene and twice with 10 ml heptane). The first wash with toluene was conducted at 90° C. and the others at room temperature. The product was dried in vacuum.

### Examples 4 and 5

Preparation of Catalysts CAT4 and CAT5

PEI and TiCl₄ were added to δ-MgCl₂ simultaneously using toluene as solvent. δ-MgCl₂, PEI, TiCl₄ and toluene were packed to an autoclave, which was heated at 100° C. for 2 h. Different Mg/donor molar ratios were used to obtain catalysts with different PEI contents. Ti/Mg molar ratio of 10:1 was used. The product was washed as in the case of CAT3.

Comparative Catalyst 1 (C-CAT1)

C-CAT1 refers to the comparative catalyst which was prepared as above, but without any electron donor.

Ethylene Homopolymerization

Ethylene polymerization was conducted as in example 2. The chemical compositions and the activities of the catalysts CAT3, CAT4, CAT5 and C-CAT1 in ethylene polymerization are presented in Table 3.

TABLE 3
Chemical compositions and activities of the catalysts
CAT3, CAT4, CAT5 and C-CAT1 in ethylene polymerisation

| | Mg | PEI | Ti | Activity |
|---|---|---|---|---|
| | wt-% | wt-% | wt-% | gPE/(gcat*h) |
| C-CAT1 | 25.0 | 0.0 | 2.0 | 79 |
| CAT3 | 21.3 | 6.4 | 2.0 | 40 |
| CAT4 | 19.3 | 8.3 | 3.3 | 137 |
| CAT5 | 14.4 | 10.2 | 7.7 | 178 |

Activities of CAT4 and CAT5 were higher than that of the comparative catalyst

Bench-Scale Ethylene Copolymerization with 1-Butene

The catalyst was tested in copolymerization with 1-butene. Triethylaluminum (TEA) was used as a co-catalyst with an Al/Ti molar ratio of 15. The polymerization reaction was carried out in a 3 L bench-scale reactor in accordance with the following procedure: An empty 3 L bench-scale reactor was charged with 55 mL of 1-butene at 20° C. and stirred at 200 rpm. Then 1250 mL of propane was added to the reactor as a polymerization medium, followed by the addition of hydrogen gas (0.75 bar). The reactor was heated to 85° C., and ethylene (3.7 bar) was added batch wise (final molar ratio C4/C2 is 770 mol/mol). The catalyst and the co-catalyst were added together (a few seconds of pre-contact between catalyst and TEA) to the reactor with additional 100 mL of propane. The total reactor pressure was maintained at 38.3 within +/−0.2 bar accuracy by continuous ethylene feed. The polymerization was stopped after 60 min by venting off the monomers and H₂. The obtained polymer was left to dry in a fume hood overnight before weighing. Ethylene-1-butene polymerisation results are disclosed in Table 4. As catalysts were used CAT1, CAT2 and C-CAT2.

Comparative Catalyst 2 (C-CAT2)

As Comparative catalyst C-CAT2 was used a catalyst prepared by the following method:

Complex Preparation:

87 kg of toluene was added into the reactor. Then 45.5 kg Bomag A in heptane was also added in the reactor. 161 kg 99.8% 2-ethyl-1-hexanol was then introduced into the reactor at a flow rate of 24-40 kg/h. The molar ratio between BOMAG-A and 2-ethyl-1-hexanol was 1:1.83.

Solid Catalyst Component Preparation:

275 kg silica (ES747JR of Crossfield, having average particle size of 20 μm) activated at 600° C. in nitrogen was charged into a catalyst preparation reactor. Then, 411 kg 20% EADC (2.0 mmol/g silica) diluted in 555 litres pentane was added into the reactor at ambient temperature during one hour. The temperature was then increased to 35° C. while stirring the treated silica for one hour. The silica was dried at 50° C. for 8.5 hours. Then 655 kg of the complex prepared as described above (2 mmol Mg/g silica) was added at 23° C. during ten minutes. 86 kg pentane was added into the reactor at 22° C. during ten minutes. The slurry was stirred for 8 hours at 50° C. Finally, 52 kg TiCl₄ was added during 0.5 hours at 45° C. The slurry was stirred at 40° C. for five hours. The catalyst was then dried by purging with nitrogen.

TABLE 4
Ethylene-1-butene polymerisation results

| | Activity | C4 | MFR2 | MFR21 | Mp | |
|---|---|---|---|---|---|---|
| Catalyst | Kg PE/(gcat*h) | wt % | g/10 min | g/10 min | ° C. | FFR21/2 |
| CAT1 | 11 | 4.3 | 0.91 | 24.5 | 125.0 | 27 |
| CAT2 | 9.5 | 3.8 | 0.98 | 22.4 | 124.6 | 22.9 |
| C-CAT2 | 6.2 | 4.1 | 2.3 | 56 | 123.2 | 24.3 |

The activity of the catalysts CAT1 and CAT2 was about double of the activity of C-CAT2.

1. A solid Ziegler-Natta catalyst component comprising transition metal compound of Group 4 to 6, and a nitrogen containing polymeric internal electron donor.

2. The solid Ziegler-Natta catalyst component according to claim 1, wherein the polymeric internal electron donor is selected from linear or branched polyalkyleneimines of formula I, or isomers or mixtures therefrom
H₂N—(CH₂)ₐ—[(CH₂)_{b}—(N(R¹)-L-)ₙ-(CH₂)_{c}]ₘ—(CH₂)_{d}—NH₂ (I)
wherein,
each a, b, c and d is an integer of 1 to 4,
n is an integer 3 to 7,
m is an integer 2 to 100,
each L is independently an alkylene of 1 to 4 C-atoms,
each R¹ is independently H, or a group -L-(N(R²)_{z}(R³)_{y}, wherein L is as defined above,
each R² and R³ are independently H or an C₁ to C₄ amino alkyl, and
z and y are 0, 1 or 2, provided that the sum z+y is 2.

3. The solid Ziegler-Natta catalyst component according to claim 2, wherein each a, b, c and d are 2 and L is ethylene.

4. The solid Ziegler-Natta catalyst component according to claim 2, wherein at least one of R¹ in formula (I) is a group -L-(N(R²)_{z}(R³)_{y}.

5. The solid Ziegler-Natta catalyst component according to claim 2, wherein at least one of R² and R³ is an amino C₁ to C₄ alkyl.

6. The solid Ziegler-Natta catalyst component according to claim 1, wherein the transition metal compound of Group 4 to 6 is a transition metal compound of Group 4.

7. The solid Ziegler-Natta catalyst component according to claim 1, wherein the catalyst component is supported on a particulate support.

8. A Ziegler-Natta catalyst comprising the solid Ziegler-Natta catalyst component according to claim 1 and a cocatalyst selected from organometallic compounds of Group 13 metal.

9. A method for producing a solid Ziegler-Natta catalyst component as defined in claim 1, comprising adding a nitrogen containing polymeric internal electron donor during synthesis of the Ziegler-Natta catalyst.

10. The method for producing a solid Ziegler-Natta catalyst component according to claim 9 comprising
i) providing solid MgCl₂ based support,
ii) contacting the solid MgCl₂ based support of step i) with the polymeric internal electron donor of formula I, or isomers or mixtures therefrom
H₂N—(CH₂)ₐ—[(CH₂)_{b}—(N(R¹)-L-)ₙ-(CH₂)_{c}]ₘ—(CH₂)_{d}—NH₂ (I)
wherein,
each a, b, c and d is an integer of 1 to 4,
n is an integer 3 to 7,
m is an integer 2 to 100,
each L is independently an alkylene of 1 to 4 C-atoms,
each R¹ is independently H, or a group -L-(N(R²)_{z}(R³)_{y}, wherein L is as defined above,
each R² and R³ are independently H or an C₁ to C₄ amino alkyl, and
z and y are 0, 1 or 2, provided that the sum z+y is 2,
iii) treating the solid support obtained in step ii) with TiCl₄ or
iii′) simultaneously with step ii) contacting the solid support with TiCl₄, and
iv) recovering the solid Ziegler-Natta catalyst component.

11. The method according to claim 10, wherein each a, b, c and d are 2 and L is ethylene.

12. The method according to claim 10, wherein at least one of R¹ in formula (I) is a group -L-(N(R²)_{z}(R³)_{y}.

13. The method according to claim 10, wherein at least one of R² and R³ is an amino C₁ to C₄ alkyl, preferably an amino ethyl group.

14. A method of using a nitrogen containing polymeric internal electron as defined in claim 1, the method comprising using the nitrogen containing polymeric internal electron as an internal electron donor in solid Ziegler-Natta catalysts.

15. A process for producing C₂ to C₆ olefin (co)polymers comprising polymerizing a C₂ to C₆ olefin or a mixture thereof in the presence of the solid Ziegler-Natta catalyst component as defined in claim 1.

16. The process according to claim 15, wherein a solid Ziegler-Natta catalyst is used, wherein the Ziegler-Natta catalyst comprises the solid Ziegler-Natta catalyst component and a cocatalyst selected from organometallic compounds of Group 13.

17. A process for producing C₂ to C₆ olefin (co)polymers comprising polymerizing a C₂ to C₆ olefin or a mixture thereof in the presence of the solid Ziegler-Natta catalyst component as produced according to the method of claim 9.
